(19) United States
(12) Patent Application Publication
(10) Pub. No.: US 2011/0129596 A1
(43) Pub. Date: Jun. 2, 2011

(54) Deposition apparatus and method of manufacturing organic light emitting device using the same

(75) Inventors: Jung-Min Lee, Yongin-City (KR); Choong-Ho Lee, Yongin-City (KR); Yoon-Chan Oh, Yongin-City (KR); Soo-Jin Park, Yongin-City (KR)

(73) Assignee: Samsung Mobile Display Co., Ltd., Yongin-City (KR)

(21) Appl. No.: 12/801,601

(22) Filed: Jun. 16, 2010

(30) Foreign Application Priority Data
Dec. 1, 2009 (KR) 10-2009-0117833

(51) Int. Cl. B05D 5/12; B05C 9/00; B05D 3/00

(52) U.S. Cl. 427/64; 118/72; 427/444

(57) ABSTRACT

A deposition apparatus that improves deposition characteristics and the uniformity of a deposited layer, and a method of manufacturing an organic light emitting device using the deposition apparatus. The deposition apparatus includes: a base; a heat blocking layer formed on the base; a heat emitting layer patterned into stripes and formed on the heat blocking layer to heat a deposition material to be deposited; and a barrier rib formed and patterned on the heat blocking layer to define a space in which the deposition material is disposed.

### CLAIM OF PRIORITY

This application makes reference to, incorporates the same herein, and claims all benefits accruing under 35 U.S.C. §119 from an application earlier filed in the Korean Intellectual Property Office on Dec. 1, 2009 and there duly assigned Serial No. 10-2009-0117833.

### BACKGROUND OF THE INVENTION

1. Field of the Invention

The present invention relates to a deposition apparatus and a method of manufacturing an organic light emitting device using the same and, more particularly, to a deposition apparatus that improves deposition characteristics and the uniformity of a deposited layer.

2. Description of the Related Art

Electronic devices include a fine thin film, and various methods are used to form such a fine thin film. In particular, flat panel display devices are manufactured by forming a plurality of thin films. Accordingly, in order to improve the characteristics of the flat panel display devices, the characteristics of the thin films need to be improved.

Organic light emitting devices, among flat panel display devices, have drawn attention as the next-generation display devices because of their wide viewing angle, high contrast ratio, and high response speed.

An organic light emitting layer, which emits visible light, and organic layers disposed around the organic light emitting layer in an organic light emitting device are formed by various methods, such as, a vacuum deposition, for example, that is a simple process. Vacuum deposition involves heating a deposition material in a powder or solid state and forming a deposited layer in a desired portion.

A dotted deposition source, a linear deposition source, or a plate-shaped deposition source is used in the vacuum deposition. If the dotted deposition source is used in the vacuum deposition, since a deposition material is dispersed in a wide substrate from the dotted deposition source, it is difficult to ensure high uniformity of a deposited layer.

If the linear deposition source is used in the vacuum deposition, powder is put in a crucible that longitudinally extends in one direction, and the crucible is heated to form a deposited layer. Since a deposition process is performed while the linear deposition source or a substrate is moved, it is difficult to obtain uniform deposition characteristics.

If the plate-shaped deposition source is used in the vacuum deposition, the plate-shaped deposition source is formed to have a size corresponding to a target on which a deposition material is to be deposited, and a deposition process may be performed without moving the deposition source or the substrate. However, it is difficult to maintain a constant temperature over an entire area of the target, thereby making it difficult to obtain uniform deposition characteristics. Also, as the size of the target increases, there is a limitation in improving deposition characteristics.

### SUMMARY OF THE INVENTION

The present invention provides a deposition apparatus that improves deposition characteristics and the uniformity of a deposited layer, and an organic light emitting device using the deposition apparatus.

According to an aspect of the present invention, a deposition apparatus includes: a base; a heat blocking layer formed on the base; a heat emitting layer patterned into stripes and formed on the heat blocking layer to heat a deposition material to be deposited; and a barrier rib formed and patterned on the heat blocking layer to define a space in which the deposition material is disposed.

The heat blocking layer may include at least one selected from the group consisting of ZrO₂ (Zirconium Oxide or Zirconia), SiO₂ (Silicon Dioxide), and Al₂O₃ (Aluminum Oxide).

The heat blocking layer may be formed over an entire surface of the base facing the heat emitting layer.

The heat emitting layer may be formed to have a plurality of stripe patterns.

Each of the plurality of stripe patterns may have a uniform width from an end to the other end.

The plurality of stripe patterns may have the same width.

The barrier rib may be formed to have a plurality of stripe patterns that are disposed between the plurality of stripe patterns of the heat emitting layer.

The heat emitting layer may be connected to one common power source.

The heat emitting layer may include at least one selected from the group consisting of titanium (Ti), chrome (Cr), copper (Cu), and aluminium (Al).

The heat emitting layer may include a first heat emitting layer, a second heat emitting layer, and a third heat emitting layer to enable different deposition materials to be disposed.

The first heat emitting layer, the second heat emitting layer, and the third heat emitting layer may be connected to different power sources.

Each of the first heat emitting layer, a second heat emitting layer, and a third heat emitting layer may be formed to have a plurality of stripe patterns.

Each of the plurality of stripe patterns may have a uniform width from one end to the other end.

The plurality of stripe patterns of the first heat emitting layer may have the same width, the plurality of stripe patterns of the second heat emitting layer may have the same width, and the plurality of stripe patterns of the third heat emitting layer may have the same width.

The barrier rib may be formed to have a plurality of stripe patterns that are disposed between the plurality of stripe patterns of the first through third heat emitting layers.

The barrier rib may include a first barrier rib and a second barrier rib intersecting the first barrier rib.

The second barrier rib may be disposed on the heat emitting layer.

An entire area of the heat emitting layer may have a uniform width.

According to another aspect of the present invention, a method of manufacturing an organic light emitting device utilizes a deposition apparatus including a base, a heat blocking layer formed on the base, a heat emitting layer patterned into stripes and formed on the heat blocking layer to heat a deposition material to be deposited, and a barrier rib formed and patterned on the heat blocking layer to define a space in which the deposition material is disposed, the method including: preparing a substrate including a first electrode, and a pixel definition layer disposed on the first electrode to expose a portion of the first electrode; forming an organic light emitting layer, which is electrically connected to the first electrode, by using the deposition apparatus; and forming a second electrode on the organic light emitting layer.

The forming of the organic light emitting layer by using the deposition material may include disposing the substrate and the deposition apparatus so that the pixel definition layer and the barrier rib contact each other.

The method may further include forming a hole transport/injection layer on the first electrode before the forming of the organic light emitting layer.

Accordingly, the deposition apparatus and the method of manufacturing the organic light emitting device using the same according to the present invention may improve deposition characteristics and the uniformity of the deposited layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a plan view of a deposition apparatus according to an embodiment of the present invention;

FIG. 2 is a cross-sectional view taken along line II-II of FIG. 1;

FIG. 3 is a plan view of a deposition apparatus according to another embodiment of the present invention;

FIG. 4 is a cross-sectional view taken along line IV-IV of FIG. 3;

FIG. 5 is a plan view of a deposition apparatus according to another embodiment of the present invention;

FIG. 6 is a cross-sectional view taken along line VI-VI of FIG. 5;

FIG. 7 is a cross-sectional view taken along line VII-VII of FIG. 5;

FIGS. 8A through 8F are cross-sectional views illustrating a method of manufacturing an organic light emitting device, according to an embodiment of the present invention;

FIGS. 9A through 9E are cross-sectional views illustrating a method of manufacturing to an organic light emitting device, according to another embodiment of the present invention; and

FIGS. 10A through 10E are cross-sectional views illustrating a method of manufacturing an organic light emitting device, according to another embodiment of the present invention.

### DETAILED DESCRIPTION OF THE INVENTION

The present invention will now be described more fully with reference to the accompanying drawings, in which exemplary embodiments of the invention are shown.

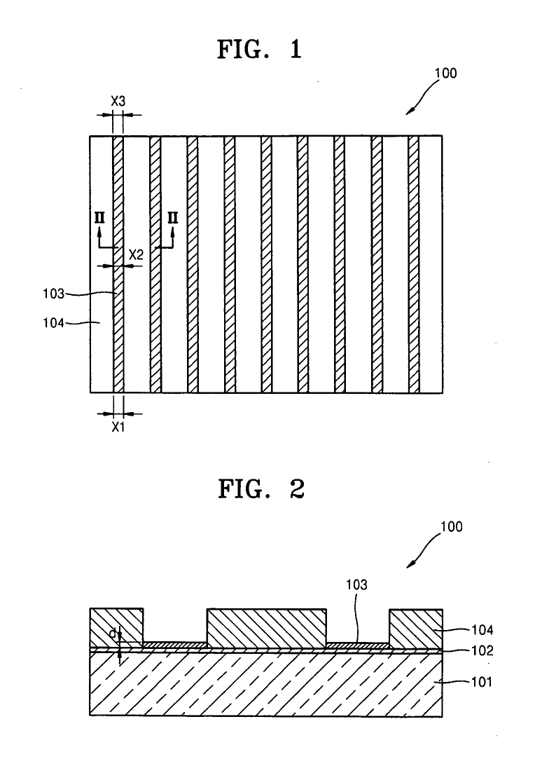

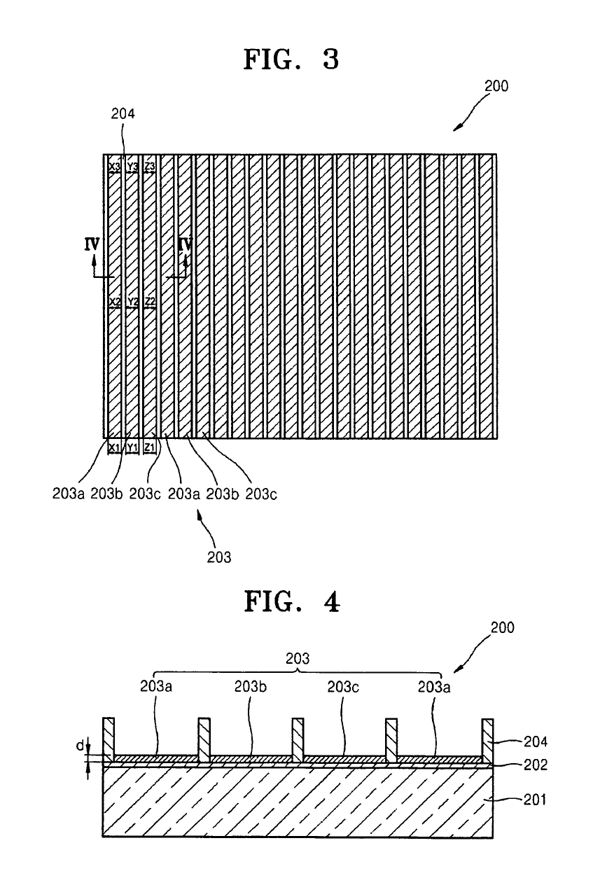

FIG. 1 is a plan view of a deposition apparatus 100 according to an embodiment of the present invention, and FIG. 2 is a cross-sectional view taken along line II-II of FIG. 1.

Referring to FIGS. 1 and 2, the deposition apparatus 100 includes a base 101, a heat blocking layer 102, a heat emitting layer 103, and a barrier rib 104.

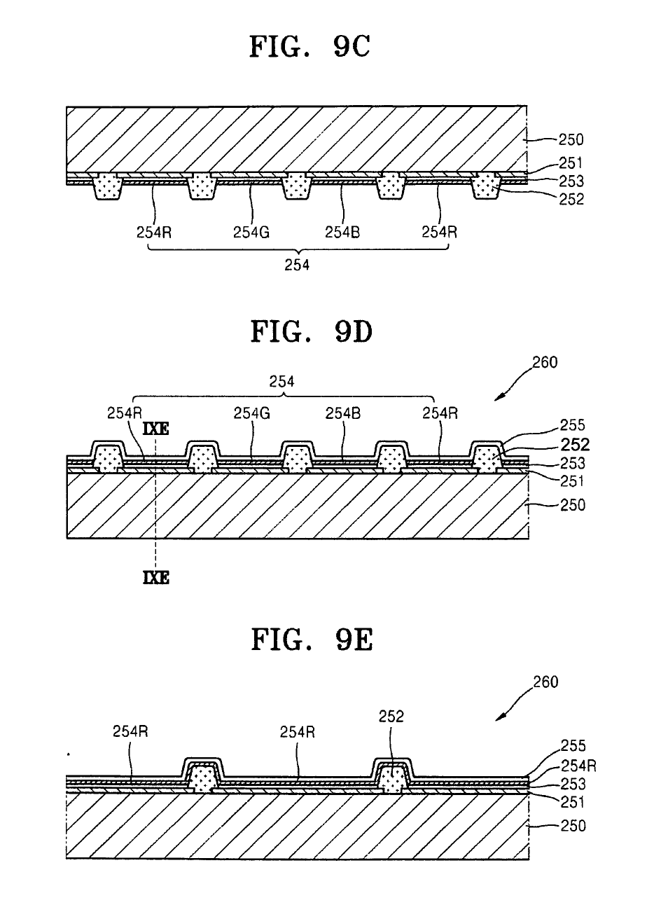

The deposition apparatus 100 may face a target (see FIGS. 8A through 8F), and may be connected to a structure to which a vacuum pump for performing a deposition process in a vacuum atmosphere is connected. The deposition apparatus 100 and the target may be disposed in a vacuum chamber.

The deposition apparatus 100 is a plate-shaped deposition apparatus for depositing a deposition material partially or entirely on a surface of a target.

As the deposition material is evaporated, a deposited layer is formed on the target. The heat emitting layer 103 is disposed on the base 101 to heat the deposition material.

Since the base 101 is used to support the deposition apparatus 100, the base 101 needs to be formed of a material having high durability and low deformation due to heat generated by the heat emitting layer 103. Also, the base 101 needs to be formed of a material having small surface defects and a low thermal expansion coefficient. To this end, the base 101 may be formed of quartz. However, the present embodiment is not limited thereto, and the base 101 may be formed by performing ceramic coating on a glass plate or a ceramic plate.

The heat blocking layer 102 is formed on the base 101. The heat blocking layer 102 contacts the heat emitting layer 103 and prevents heat generated by the heat emitting layer 103 from being transmitted to the base 101, thereby improving the efficiency of the heat emitting layer 103 and preventing thermal interference between a plurality of the heat emitting layers 103. To this end, the heat blocking layer 102 includes an insulating material having no surface defects and a low heat transfer coefficient. In detail, the heat blocking layer 102 may include at least one selected from the group consisting of ZrO₂ (Zirconium Oxide or Zirconia), SiO₂ (Silicon Dioxide), and Al₂O₃ (Aluminum Oxide).

The heat blocking layer 102 may be formed over an entire top surface of the base 101 in order to effectively block heat generated by the heat emitting layer 103.

The heat blocking layer 102 may be formed by applying, drying, and heating a ceramic material, or may be formed by electrolyte coating.

The heat emitting layer 103 is formed on the heat blocking layer 102. The heat emitting layer 103 has a plurality of stripe patterns that are spaced apart from one another by a predetermined distance. The heat emitting layer 103 for heating the deposition material is formed of a conductive material and is connected to a separate power source (not shown). The heat emitting layer 103 heats the deposition material using Joule heat generated by the heat emitting layer 103 when the heat emitting layer 103 receives a voltage applied by the power source.

The heat emitting layer 103 includes at least one selected from the group consisting of titanium (Ti), chrome (Cr), copper (Cu), and aluminium (Al). The stripe patterns of the heat emitting layer 103 have uniform width. That is, a width X1 of one end of one stripe pattern of the heat emitting layer 103 is the same as a width X3 of the other end of the one stripe pattern of the heat emitting layer 103. A width X2 of a middle portion between the one end and the other end of the one stripe pattern of the heat emitting layer 103 is also the same as the width X1. Accordingly, an entire area of each of the plurality of stripe patterns of the heat emitting layer 103 from one end to the other end may provide the same heat emitting characteristics. Although the plurality of stripe patterns of the heat emitting layer 103 may be able to have different widths, it is preferable that the plurality of stripe patterns of the heat emitting layer 103 may have the same width. That is, the plurality of stripe patterns of the heat emitting layer 103 may have the same width X1.

If an organic light emitting layer for emitting the same visible light in an organic light emitting device using the deposition apparatus 100 is formed, the heat emitting layer 103 may be formed to have a plurality of stripe patterns having the same width.

Also, the plurality of stripe patterns of the heat emitting layer 103 may have the same thickness d.

The heat emitting layer 103 may be formed by photolithography to have the plurality of stripe patterns. However, the present embodiment is not limited thereto, and the heat emitting layer 103 may be formed by cutting a metal foil using a laser and adhering the metal foil to the base 101.

The heat emitting layer 103 may be connected to one common power source. When a deposited layer is formed using the deposition material, the characteristics of the deposited layer vary according to a heating speed, heating duration, and heating temperature of the deposition material. It is preferable that the organic light emitting layer for emitting light of the same color in the organic light emitting device may have constant characteristics. Accordingly, if the organic light emitting layer for emitting the same visible light in the organic light emitting device using the deposition apparatus 100 is formed, the heat emitting layer 103 may be formed to have the plurality of stripe patterns having the same width.

The barrier rib 104 is formed on the heat blocking layer 102. The barrier rib 104 is formed adjacent the heat emitting layer 103. The barrier rib 104 is formed to have a plurality of stripe patterns that are disposed between the plurality of stripe patterns of the heat emitting layer 103.

Since the deposition material is disposed in a space defined by the barrier rib 104, the height of the barrier rib 104 is determined by considering a desired amount of the deposition material. The barrier rib 104 is formed of a material having low thermal conductivity, for example, a ceramic material. The barrier rib 104 may be formed of a photosensitive material, or a mixture of a photosensitive material and glass frit.

The deposition apparatus 100 includes the barrier rib 104 that is formed to have desired patterns. The deposited layer having desired patterns is formed by disposing the deposition material on the heat emitting layer 103 that is disposed in spaces defined by a plurality of the barrier ribs 104 and performing a deposition process. That is, the deposited layer having the desired patterns may be formed without using an additional mask.

The deposition apparatus 100 has the heat blocking layer 102 disposed between the heat emitting layer 103 and the base 101 so that heat generated by the heat emitting layer 103 is prevented from being transmitted to the base 101. The characteristics of the deposited layer vary according to a heating time, a heating speed, and a heating temperature of the deposition material. If the heat generated by the heat emitting layer 103 is transmitted to the base 101, the heat non-uniformly heats the deposition material, thereby forming a non-uniform deposited layer. However, since the heat generated by the heat emitting layer 103 is prevented by the heat blocking layer 102 from being transmitted to the base 101, a uniform deposition layer is easily formed.

The heat emitting layer 103 having the plurality of stripe patterns is connected to the power source and generates heat due to its resistance when a voltage is applied by the power source to the heat emitting layer. The amount of heat varies according to the width and thickness of the heat emitting layer 103. The variation in the amount of heat leads to non-uniform heating of the deposition material and non-uniform characteristics of the deposited layer according to regions. However, each of the plurality of stripe patterns of the heat emitting layer 103 has a uniform width and thickness. Accordingly, an entire area of each of the plurality of stripe patterns of the heat emitting layer 103 from one end to the other end emits the same heat, thereby uniformly heating the deposition material disposed on each of the plurality of stripe patterns of the heat emitting layer 103. Also, the plurality of stripe patterns of the heat emitting layer 103 have the same width. Accordingly, an entire area of the heat emitting layer emits the same heat, thereby uniformly heating the deposition material disposed on the heat emitting layer 103. As a result, a deposited layer having uniform characteristics may be easily formed.

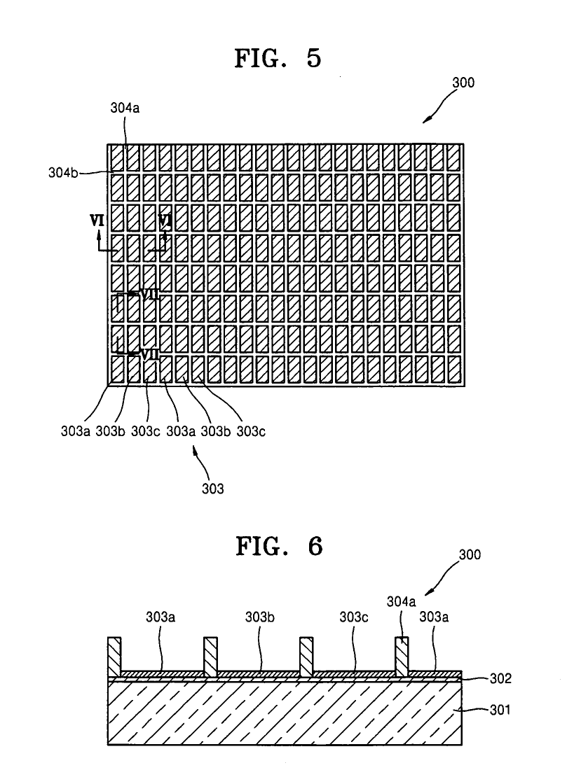

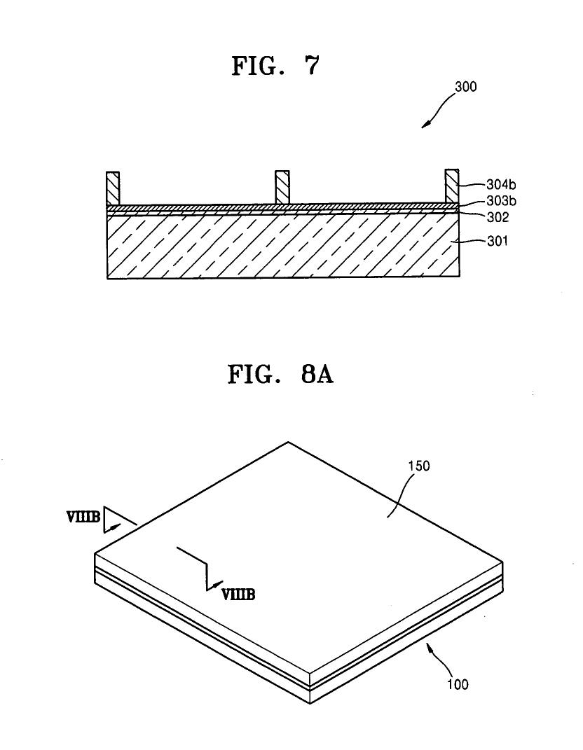

FIG. 3 is a plan view of a deposition apparatus 200 according to another embodiment of the present invention, and FIG. 4 is a cross-sectional view taken along line IV-IV of FIG. 3. For convenience, the following explanation will be made by focusing on a difference between the deposition apparatus 100 of FIG. 1 and the deposition apparatus 200 of FIG. 3.

Referring to FIGS. 3 and 4, the deposition apparatus 200 includes a base 201, a heat blocking layer 202, a heat emitting layer 203, and a barrier rib 204.

The deposition apparatus 100 of FIG. 1 performs a deposition process by using one deposition material. That is, if an organic light emitting device includes organic light emitting layers for emitting lights of three colors, the deposition apparatus 100 of FIG. 1 may form an organic light emitting layer for emitting light of one color from among the organic light emitting layers by performing one deposition process. In order to form all of the organic light emitting layers, the deposition apparatus 100 of FIG. 1 performs three deposition processes.

The deposition apparatus 200 of FIG. 3 may perform a deposition process by using different deposition materials, and may form organic light emitting layers of an organic light emitting device by performing one deposition process.

The heat blocking layer 202 may be formed over an entire top surface of the base 201.

The heat emitting layer 203 is formed on the heat blocking layer 202. The heat emitting layer 203 includes a first heat emitting layer 203a, a second heat emitting layer 203b, and a third heat emitting layer 203c. The first heat emitting layer 203a, the second heat emitting layer 203b, and the third heat emitting layer 203c are formed as stripes that are spaced apart from one another by a predetermined distance. Each of the first heat emitting layer 203a, the second heat emitting layer 203b, and the third heat emitting layer 203c includes a plurality of stripe patterns, and the first heat emitting layer 203a, the second heat emitting layer 203b, and the third heat emitting layer 203c may be repeatedly disposed in the same order.

Each of the plurality of stripe patterns of the first heat emitting layer 203a has a uniform width. That is, a width X1 of one end of one stripe pattern of the first heat emitting layer 203a is the same as a width X3 of the other end of the one stripe pattern of the first heat emitting layer 203a. Also, a width X2 of a middle portion between the one end and the other end of the one stripe pattern of the first heat emitting layer 203a is the same as the width X1. Accordingly, an entire area of each of the plurality of stripe patterns of the first heat emitting layer 203a from one end to the other end may provide the same heat emitting characteristics. Also, the plurality of stripe patterns of the first heat emitting layer 203a have the same width. That is, the plurality of stripe patterns of the first heat emitting layer 203a have the same width X1.

Each of the plurality of stripe patterns of the second heat emitting layer 203b has a uniform width. That is, a width Y1 of one end of one stripe pattern of the second heat emitting layer 203b is the same as a width Y3 of the other end of the one stripe pattern of the second heat emitting layer 203b. Also, a width Y2 of a middle portion between the one end and the other end of the one stripe pattern of the second heat emitting layer 203b is the same as the width Y1. Accordingly, an entire area of each of the plurality of stripe patterns of the second heat emitting layer 203b from one end to the other end may provide the same heat emitting characteristics. Also, the plurality of stripe patterns of the second heat emitting layer 203b have the same width. That is, the plurality of stripe patterns of the second heat emitting layer 203b may have the same width Y1.

Likewise, each of the plurality of stripe patterns of the third heat emitting layer 203c has a uniform width. That is, a width Z1 of one end of one stripe pattern of the third heat emitting layer 203c is the same as a width Z3 of the other end of the one stripe pattern of the third heat emitting layer 203c. Also, a width Z2 of a middle portion between the one end and the other end of the one stripe pattern of the third heat emitting layer 203c is the same as the width Z1. Accordingly, an entire area of each of the plurality of stripe patterns of the third heat emitting layer 203c from one end to the other end may provide the same heat emitting characteristics. Also, the plurality of stripe patterns of the third heat emitting layer 203c have the same width. That is, the plurality of stripe patterns of the third heat emitting layer 203c may have the same width Z1.

The width X1 of the first heat emitting layer 203a, the width Y1 of the second heat emitting layer 203b, and the width Z1 of the third heat emitting layer 203c may be the same. However, the present embodiment is not limited thereto, and the width X1 of the first heat emitting layer 203a, the width Y1 of the second heat emitting layer 203b, and the width Y1 of the third heat emitting layer 203c may be different from one another.

The first heat emitting layer 203a is connected to one common power source. The second heat emitting layer 203b is connected to another common power source, and the third heat emitting layer 203c is connected to yet another common power source. The common power sources to which the first heat emitting layer 203a, the second heat emitting layer 203b, and the third heat emitting layer 203c are respectively connected are different from one another. That is, the heat emitting layer 203 is connected to three power sources.

When a deposited layer is formed by using a deposition material, the characteristics of the deposited layer vary according to a heating speed, a heating time, and a heating temperature of the deposition material. An organic light emitting device typically includes organic light emitting layers for emitting light of three colors, for example, a red organic light emitting later, a green organic light emitting layer, and a blue organic light emitting layer.

Since the three organic light emitting layers have different light emitting characteristics, the three organic light emitting layers may have different thicknesses. Also, since different deposition materials are used to form the three organic light emitting layers, evaporation speeds or sublimation speeds of the different deposition materials are different from one another. Accordingly, if the three deposition materials are disposed and then a deposition process is performed on the three deposition materials in order to form the three organic light emitting layers at once, there is a limitation in obtaining a deposited layer having desired characteristics.

The deposition apparatus 200 of FIG. 3 includes the first heat emitting layer 203a, the second heat emitting layer 203b, and the third heat emitting layer 203c which are respectively connected to the different power sources. Accordingly, the magnitude and time of a voltage applied to each of the first heat emitting layer 203a, the second heat emitting layer 203b, and the third heat emitting layer 203c may be controlled. A deposited layer having desired characteristics may be obtained by disposing different deposition materials on the first heat emitting layer 203a, the second heat emitting layer 203b, and the third heat emitting layer 203c and then performing one deposition process.

In particular, if organic light emitting layers for emitting light of three colors in an organic light emitting device using the deposition apparatus 200 need to be simultaneously formed, the organic light emitting layers having desired characteristics may be easily formed by individually controlling voltages applied to the first heat emitting layer 203a, the second heat emitting layer 203b, and the third heat emitting layer 203c and performing one deposition process.

The barrier rib 204 is formed on the heat blocking layer 202. The barrier rib 204 is formed adjacent to the heat emitting layer 203. The barrier rib 204 is formed to have a plurality of stripe patterns that are disposed between the stripe patterns of the heat emitting layer 203.

Since materials and manufacturing methods of the base 201, the heat blocking layer 202, the heat emitting layer 203, and the barrier rib 204 are the same as those of the deposition apparatus 100 of FIG. 1, a detailed explanation thereof will not be given.

The deposition apparatus 200 of FIG. 3 may realize a desired deposited layer having desired patterns without using an additional mask. Since the heat blocking layer 202 is disposed between the heat emitting layer 203 and the base 201, heat generated by the heat emitting layer 203 may be prevented from being transmitted to the base 201, and thus thermal interference between the first heat emitting layer 203a, the second heat emitting layer 203b, and the third heat emitting layer 203c of the heat emitting layer 203. That is, heat generated by the first heat emitting layer 203a may be prevented from being transmitted to the second heat emitting layer 203b or the third heat emitting layer 203c. Accordingly, a uniform deposited layer may be easily formed.

The heat emitting layer 203 includes the first heat emitting layer 203a, the second heat emitting layer 203b, and the third heat emitting layer 203c each having the plurality of stripe patterns. Each of the plurality of stripe patterns of the heat first emitting layer 203a has a uniform width X1 and thickness d. Accordingly, an entire area of the heat emitting layer has a uniform thickness, and an entire area of each of the plurality of stripe patterns of the first heat emitting layer 203a from one end to the other end generates the same heat, thereby uniformly heating the deposition material disposed on each of the plurality of stripe patterns of the first heat emitting layer 203a.

Likewise, an entire area of each of the plurality of stripes of each of the second heat emitting layer 203b and the third heat emitting layer 203c generates the same heat, respectively.

Since the deposition apparatus 200 includes the first heat emitting layer 203a, the second heat emitting layer 203b, and the third heat emitting layer 203c respectively connected to the different power sources, a deposited layer having desired characteristics may be obtained by performing one deposition process.

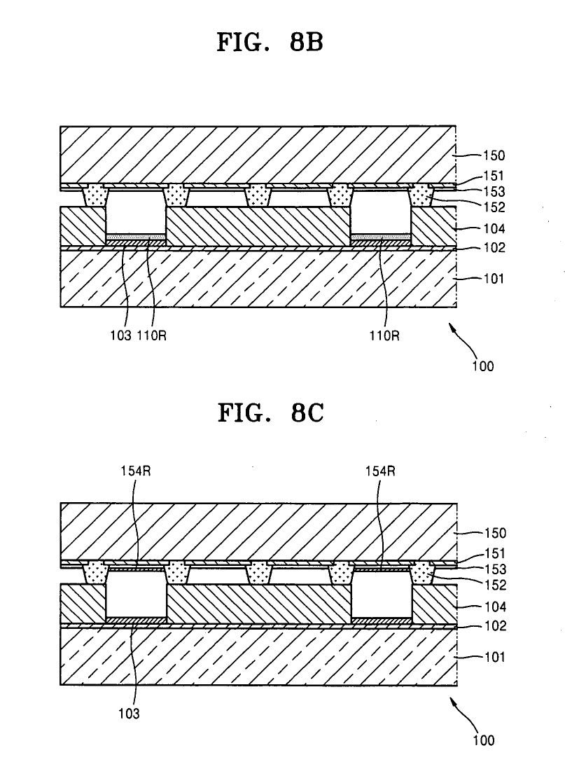

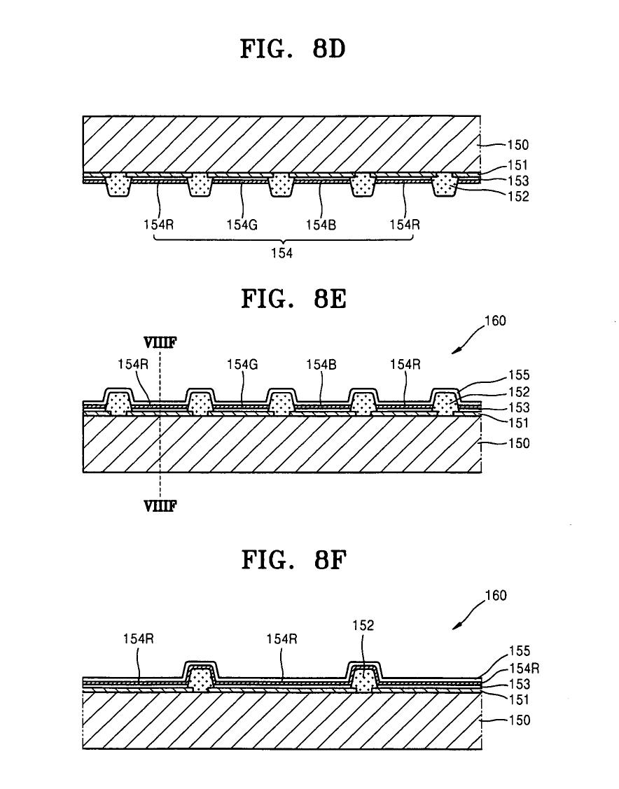

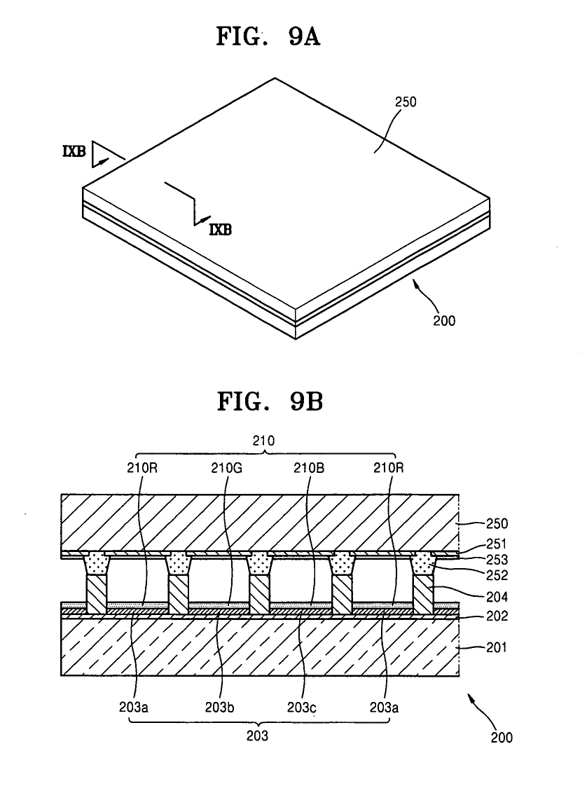

FIG. 5 is a plan view of a deposition apparatus 300 according to another embodiment of the present invention, and FIG. 6 is a cross-sectional view taken along line VI-VI of FIG. 5. FIG. 7 is a cross-sectional view taken along line VII-VII of FIG. 5. For convenience, the following explanation will be made by focusing on a difference between the deposition apparatus 300 of FIG. 5 and the deposition apparatuses 100 and 200 of FIGS. 1 and 3.

Referring to FIGS. 5 through 7, the deposition apparatus 300 includes a base 301, a heat blocking layer 302, a heat emitting layer 303, and barrier ribs 304a and 304b.

The deposition apparatus 300 may perform a deposition process by using different deposition materials like the deposition apparatus 200 of FIG. 3, and organic light emitting layers of an organic light emitting device may be formed by performing one deposition process.

The heat blocking layer 302 may be formed over an entire top surface of the base 301.

The heat emitting layer 303 is formed on the heat blocking layer 302. An entire area of the heat emitting layer may have a uniform thickness The heat emitting layer 303 includes a first heat emitting layer 303a, a second heat emitting layer 303b, and a third heat emitting layer 303c. The first heat emitting layer 303a, the second heat emitting layer 303b, and the third heat emitting layer 303c are formed as stripes that are spaced apart from one another by a predetermined distance. Each of the first heat emitting layer 303a, the second heat emitting layer 303b, and the third heat emitting layer 303c has a plurality of stripe patterns, and the first heat emitting layer 303a, the second heat emitting layer 303b, and the third heat emitting layer 303c are repeatedly disposed in the same order.

Each of the plurality of stripe patterns of the first heat emitting layer 303a has a uniform width. Also, the plurality of stripe patterns of the first heat emitting layer 303a have a uniform thickness.

Each of the plurality of stripe patterns of the second heat emitting layer 303b has a uniform width. Also, the plurality of stripe patterns of the second heat emitting layer 303b have a uniform thickness.

Likewise, each of the plurality of stripe patterns of the third heat emitting layer 303c has a uniform width. Also, the plurality of stripe patterns of the third heat emitting layer 303c have a uniform thickness.

The width of each of the first heat emitting layer 303a, the second heat emitting layer 303b, and the third heat emitting layer 303c may be the same. The thickness of each of the first heat emitting layer 303a, the second heat emitting layer 303b, and the third heat emitting layer 303c may be the same.

Each of the first barrier ribs 304a are formed on the heat blocking layer 302. The first barrier ribs 304a are formed adjacent the heat emitting layer 303. That is, the first barrier ribs 304a are formed to have a plurality of stripe patterns.

The second barrier ribs 304b intersect the first barrier ribs 304a. The second barrier ribs 304b are formed on the heat emitting layer 303 to perpendicularly intersect the first barrier ribs 304a.

Accordingly, a space in which a deposition material is to be deposited has a matrix or lattice shape, not a stripe shape. That is, the deposition apparatuses 100 and 200 of FIGS. 1 and 3 have stripe-shaped spaces in which a deposition material is to be deposited due to the heat emitting layers 103 and 203 and the barrier ribs 104 and 204 disposed adjacent the heat emitting layers 103 and 203 having the stripe patterns. In FIG. 5, however, since the first barrier rib 304a is formed adjacent the heat emitting layer 303 having the stripe patterns and the second barrier rib 304b is formed on the heat emitting layer 303 to intersect the first barrier ribs 304a, a space in which a deposition material is to be deposited has a matrix or lattice shape.

Due to the barrier ribs 304a and 304b, the deposition apparatus 300 may dispose a deposition material in various ways. One deposition material is disposed in the form of a stripe on one stripe pattern of the first heat emitting layer 203a of the deposition apparatus 200 of FIG. 3. However, various deposition materials may be disposed on one stripe pattern of the first heat emitting layer 303a of the deposition apparatus 300 of FIG. 5. That is, since a space on one stripe pattern of the first heat emitting layer 303a is divided by a plurality of the second barrier ribs 304b, desired deposition materials may be disposed in the space.

Since the size of each space in which a deposition material is to be deposited is reduced, the deposition material may be uniformly disposed with more ease.

The heat emitting layer 303 of the deposition apparatus 300 is connected to an external power source to receive a voltage. The first heat emitting layer 303a may be connected to one common power source, the second heat emitting layer 303b may be connected to another common power source, and the third heat emitting layer 303c may be connected to another common power source. In particular, if the same deposition material is disposed on all of the stripe patterns of the first heat emitting layer 303a, the first heat emitting layer 303a may be connected to one common power source. Likewise, if the same deposition material is disposed on all of the stripe patterns of the second heat emitting layer 303b, the second heat emitting layer 303b may be connected to one power source that is different from the power source to which the first heat emitting layer 303a is connected. Also, if the same deposition material is disposed on all of the stripe patterns of the third heat emitting layer 303c, the third heat emitting layer 303c may be connected to one power source that is different from the power source to which the first heat emitting layer 303a is connected and the power source to which the second heat emitting layer 303b is connected.

Since materials and manufacturing methods of the base 301, the heat blocking layer 302, the heat emitting layer 303, and the barrier ribs 304a and 304b are similar to those of the deposition apparatuses 100 and 200 of FIGS. 1 and 3, a detailed explanation thereof will not be given.

The deposition apparatus 300 of FIG. 5 may realize a deposited layer having desired patterns without using an additional mask, like the deposition apparatuses 100 and 200 of FIGS. 1 and 3. Also, since the heat blocking layer 302 is disposed between the heat emitting layer 303 and the base 301, a uniform deposited layer may be easily formed.

The heat emitting layer 303 includes the first heat emitting layer 303a, the second heat emitting layer 303b, and the third heat emitting layer 303c each having the plurality of stripe patterns. Since each of the plurality of stripe patterns of each of the first through third heat emitting layers 303a, 303b, and 303c has a uniform width and thickness, respectively, heat generated by each of the plurality of stripe patterns is uniform.

Since the stripe patterns of the first heat emitting layer 303a have the same width and thickness, heat generated by all of the stripe patterns of the first heat emitting layer 303a is the same. Since the stripe patterns of the second heat emitting layer 303b have the same width and thickness, heat generated by all of the stripe patterns of the second heat emitting layer 303b is the same. Since the stripe patterns of the third heat emitting layer 303c have the same width and thickness, heat generated by all of the stripe patterns of the third heat emitting layer 303c is the same.

Also, the deposition apparatus 300 of FIG. 5 includes the first barrier rib 304a and the second barrier rib 304b intersecting the first barrier rib 304a to define a space in which a deposition material is to be deposited. Accordingly, the deposition material may be disposed in various ways, and may be uniformly disposed.

Also, various deposition materials may be selectively disposed at desired positions of the heat emitting layer 303.

The deposition apparatuses 100, 200, and 300 of FIGS. 1, 3, and 5 may be used to deposit a thin film for various purposes. For example, the deposition apparatuses 100, 200, and 300 of FIGS. 1, 3, and 5 may be applied to an organic light emitting device.

FIGS. 8A through 8F are cross-sectional views illustrating a method of manufacturing an organic light emitting device, according to an embodiment of the present invention. The method will now be explained with reference to FIGS. 8A through 8F.

Referring to FIG. 8A, a substrate 150 is disposed on a deposition apparatus 100. Since the deposition apparatus 100 is the same as the deposition apparatus 100 of FIGS. 1 and 2, a detailed explanation of the configuration of the deposition apparatus 100 will not be given. The deposition apparatus 100 and the substrate 150 are disposed in a vacuum atmosphere, for example, in a vacuum chamber.

FIG. 8B is a cross-sectional view taken along line VIIIB-VIIIB of FIG. 8A. Referring to FIG. 8B, a first electrode 151, a pixel definition layer 152, and a hole transport/injection layer 153 are formed on the substrate 150. Due to the taken cross-section, what is not illustrated, but will become apparent with respect to FIG. 8F, substrate 150 has a matrix/lattice pattern formed of first electrode 151, pixel definition layer 152, and hole transport/injection layer 153.

A deposition material 110R is disposed on a heat emitting layer 103 disposed between adjacent barrier ribs 104 of the deposition apparatus 100. The heat emitting layer 103 is disposed to correspond to the hole transport/injection layer 153 formed between adjacent pixel definition layers 152. Also, the pixel definition layer 152 contacts a barrier rib 104.

In detail, the substrate 150 may be formed of a transparent glass material of which a main component is SiO₂. However, the present embodiment is not limited thereto, and the substrate 150 may be formed of a transparent plastic material such as at least one insulating organic material selected from the group consisting of polyethersulphone (PES), polyacrylate (PAR), polyetherimide (PEI), polyethyelenen napthalate (PEN), polyethyeleneterepthalate (PET), polyphenylene sulfide (PPS), polyallylate, polyimide, polycarbonate (PC), cellulose triaceltate (TAC), and cellulose acetate propionate (CAP).

The substrate 150 may be formed of a metal such as at least one selected from the group consisting of iron (Fe), chrome (Cr), manganese (Mn), nickel (Ni), titanium (Ti), molybdenum (Mo), stainless steel (SUS), an Invar alloy, an Inconel alloy, and a Kovar alloy. However, the present embodiment is not limited thereto. The substrate 150 may be foil-shaped.

A buffer layer (not shown) may be formed on a surface of the substrate 150 to obtain a smooth top surface of the substrate 150 and to prevent impure elements from penetrating into the substrate 150. The buffer layer may be formed of SiO2 and/or SiNx (Silicon Nitride).

The first electrode 151 is formed on the substrate 150. The first electrode 151 may be formed in predetermined patterns by photolithography. The patterns of the first electrode 151 may be formed as striped lines that are spaced apart from one another by a predetermined distance if the organic light emitting device is a passive matrix (PM) organic light emitting device, or may be formed to correspond to pixels if the organic light emitting device is an active matrix (AM) organic light emitting device.

The first electrode 151 is a reflective electrode or a transmissive electrode. If the first electrode 151 is a reflective electrode, the first electrode 151 is formed by forming a reflective layer using silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca), and combinations thereof, and putting indium tin oxide (ITO), indium zinc oxide (IZO), zinc oxide (ZnO), or Idium Oxide (In₂O₃) having a high work function on the reflective layer.

If the first electrode 151 is a transmissive electrode, the first electrode 151 may be formed of ITO, IZO, ZnO, or In₂O₃ having a high work function.

The pixel definition layer 152 is formed on the first electrode 151. An opening is formed in the pixel definition layer 152 to expose a portion of the first electrode 151. The pixel definition layer 152 is formed of various insulating materials.

The hole transport/injection layer 153 is formed on the exposed portion of the first electrode 151. Although the hole transport/injection layer 153 has a structure in which a hole injection layer and a hole transport layer are stacked, the present embodiment is not limited thereto, and the hole transport/injection layer 153 may have only the hole transport layer or the hole injection layer. Alternatively, the hole transport/injection layer 153 may not be formed.

The deposition material 110R disposed to correspond to the hole transport/injection layer 153 is a deposition material for forming an organic light emitting layer. The organic light emitting layer generally includes a red organic light emitting layer for emitting red visible light, a green organic light emitting layer for emitting green visible light, and a blue organic light emitting layer for emitting blue visible light. In detail, the illustrated deposition material 110R is a deposition material for forming a red organic light emitting layer for emitting red visible light.

That is, the heat emitting layer 103 has a width corresponding to red sub-pixels. The barrier rib 104 is formed around the heat emitting layer 103. The barrier rib 104 corresponds in position to green and blue sub-pixels.

The deposition material 110R may be disposed on the heat emitting layer 103 in various ways. The deposition material 110R in a powder state may be sprayed onto the heat emitting layer 103 to be smoothly seated on the heat emitting layer 103 between the plurality of the barrier ribs 104. Next, part of the deposition material 110R remaining on the barrier rib 104 is removed with a brush or the like. Alternatively, the deposition material 110R in a liquid state may be applied and then dried to be seated on the heat emitting layer 103.

Next, a deposition process is performed to heat the deposition material 110R, thereby forming the red organic light emitting layer 154R as shown in FIG. 8C. That is, the red organic light emitting layer 154R is formed by performing one deposition process.

Likewise, the green organic light emitting layer and the blue organic light emitting layer may be formed in the same manner. In detail, the deposition apparatus 100 is moved a little bit so that the heat emitting layer 103 corresponds to a portion in which the green organic light emitting layer is to be formed, a deposition material for forming the green organic light emitting layer is disposed on the heat emitting layer 103, and a deposition process is performed, thereby forming the green organic light emitting layer. Next, the deposition apparatus 100 is moved a little bit more so that the heat emitting layer 103 corresponds to a portion in which a blue organic light emitting layer is to be formed, a deposition material for forming the blue organic light emitting layer is disposed on the heat emitting layer 103, and a deposition process is performed, thereby forming the blue organic light emitting layer.

The present embodiment is not limited thereto, and a deposition apparatus for forming a green organic light emitting layer and a deposition apparatus for forming a blue organic light emitting layer may be used in addition to the deposition apparatus 100 for forming a red organic light emitting layer.

Referring to FIG. 8D, deposition apparatus 100 has been removed, and organic light emitting layer 154 comprises an organic light emitting layer 154R for emitting red visible light, an organic light emitting layer 154G for emitting green visible light, and an organic light emitting layer 154B for emitting blue visible light are illustrated.

Referring to FIG. 8E, a second electrode 155 is formed on organic light emitting layer 154 and pixel definition layer 152, thereby completely manufacturing an organic light emitting device 160.

FIG. 8F is a cross-sectional view taken along line VIIIF-VIIIF of FIG. 8E. Not illustrated in FIGS. 8B-8E, since substrate 150 has a matrix/lattice pattern formed of first electrode 151, pixel definition layer 152, and hole transport/injection layer 153, when the deposition process is performed the red organic light emitting layer 154R is formed on the pixel definition layer 152 and hole transport/injection layer 153 disposed above the stripped heat emitting layer 103.

Although not shown, an electron transport layer or an electron injection layer may be further formed between the organic light emitting layer 154 and the second electrode 155.

If the organic light emitting device 160 is a PM organic light emitting device, the second electrode 155 may be formed to have stripe patterns intersecting the patterns of the first electrode 151. If the organic light emitting device 160 is an AM organic light emitting device, the second electrode 155 may be formed over an active region in which an image is to be formed.

The second electrode 155 may be a transmissive electrode or a reflective electrode. If the second electrode 155 is a transmissive electrode, the second electrode 155 may be formed by depositing a metal having a low work function, such as Ag, Mg, Al, Pt, Pd, Au, Ni, Nd, Ir, Cr, Li, Ca, or a compound thereof, and forming an auxiliary electrode layer or a bus electrode line using a transparent conductive material such as ITO, IZO, ZnO, or In₂O₃.

If the second electrode 155 is a reflective electrode, the second electrode 155 may be formed of a metal having a low work function such as Ag, Mg, Al, Pt, Pd, Au, Ni, Nd, Ir, Cr, Li, or Ca. Although the present embodiment is described on the assumption that the first electrode 151 is an anode and the second electrode 155 is a cathode, the present embodiment is not limited thereto, and the first electrode 151 may be an anode and the second electrode 155 may be a cathode.

The organic light emitting device 160 having sub-pixels having stripe patterns is manufactured by operations of FIGS. 8E and 8F. That is, sub-pixels having the red organic light emitting layer 154R are aligned, sub-pixels having the green organic light emitting layer 154G are aligned near to the red organic light emitting layer 154R, and sub-pixels having the blue organic light emitting layer 154B are aligned near to the green organic light emitting layer 154G.

A sealing member (not shown) may be disposed to face one surface of the substrate 150. The sealing member for protecting the organic light emitting layer 154 from external moisture or oxygen is formed of a transparent material. To this end, the sealing member may be formed of glass, plastic, or a combination of an organic material and an inorganic material.

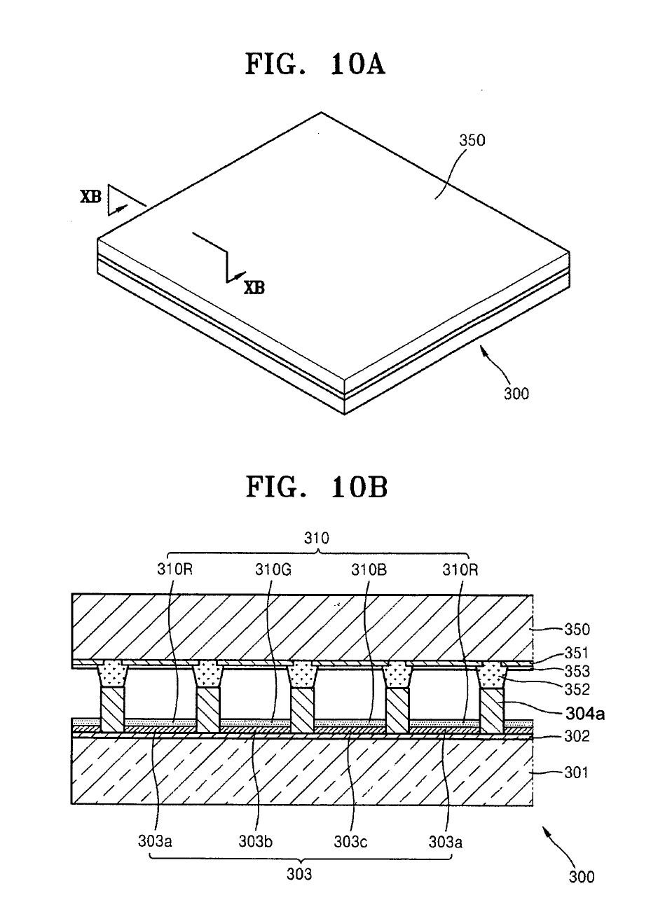

FIGS. 9A through 9E are cross-sectional views illustrating a method of manufacturing an organic light emitting device, according to another embodiment of the present invention. The method will now be explained with reference to FIGS. 9A through 9E.

Referring to FIG. 9A, a substrate 250 is disposed on a deposition apparatus 200. Since the deposition apparatus 200 is the same as the deposition apparatus 200 of FIGS. 3 and 4, a detailed explanation of the configuration of the deposition apparatus 200 will not be given. The deposition apparatus 200 and the substrate 250 are disposed in a vacuum atmosphere, for example, in a vacuum chamber.

FIG. 9B is a cross-sectional view taken along line IXB-IXB of FIG. 9A. Referring to FIG. 9B, a first electrode 251, a pixel definition layer 252, and a hole transport/injection layer 253 are formed on the substrate 250. Due to the taken cross-section, what is not illustrated, but will become apparent with respect to FIG. 9E, substrate 250 has a matrix/lattice pattern formed of first electrode 251, pixel definition layer 252, and hole transport/injection layer 253.

A heat emitting layer 203 disposed between adjacent barrier ribs 204 of the deposition apparatus 200 includes a first heat emitting layer 203a, a second heat emitting layer 203b, and a third heat emitting layer 203c. A deposition material 210R is disposed on the first heat emitting layer 203a, a deposition material 210G is disposed on the second heat emitting layer 203B, and a deposition material 210B is disposed on the third heat emitting layer 203c.

The first through third heat emitting layers 203a, 203b, and 203c are disposed to correspond to a plurality of the hole transport/injection layers 253 each formed between adjacent pixel definition layers 252. Also, the pixel definition layer 252 contacts a barrier rib 204.

The deposition material 210 for forming an organic light emitting layer includes the deposition material 210R, the deposition material 210G, and the deposition material 210B. The deposition material 210R includes an organic material for forming an organic light emitting layer for emitting red visible light, the deposition material 210G includes an organic material for forming an organic light emitting layer for emitting green visible light, and the deposition material 210B includes an organic material for forming an organic light emitting layer for emitting blue visible light.

The first heat emitting layer 203a is formed to have a width corresponding to red sub-pixels, the second heat emitting layer 203b is formed to have a width corresponding to green sub-pixels, and the third heat emitting layer 203c is formed to have a width corresponding to blue sub-pixels. The barrier rib 204 is disposed between the first through third heat emitting layers 203a, 203b, and 203c.

Next, a deposition process is performed to heat the deposition material 210R, thereby forming a red organic light emitting layer, to heat the deposition material 210G, thereby forming a green organic light emitting layer, and to heat the deposition material 210B, thereby forming a blue organic light emitting layer. That is, the red, green, and blue organic light emitting layers are formed by performing one deposition process.

Referring to FIG. 9C, deposition apparatus 200 has been removed, an organic light emitting layer 254 including an organic light emitting layer 254R for emitting red visible light, an organic light emitting layer 254G for emitting green visible light, and an organic light emitting layer 254B for emitting blue visible light are illustrated.

Referring to FIG. 9D, a second electrode 255 is formed on organic light emitting layer 254 and pixel definition layer 252, thereby completely manufacturing an organic light emitting device 260.

FIG. 9E is a cross-sectional view taken along line IXE-IXE of FIG. 9D. Not illustrated in FIGS. 9B-9D, since substrate 250 has a matrix/lattice pattern formed of first electrode 251, pixel definition layer 252, and hole transport/injection layer 253, when the deposition process is performed the red organic light emitting layer 254R is formed on the pixel definition layer 252 and hole transport/injection layer 253 disposed above the stripped heat emitting layer 203a.

Although not shown, an electron transport layer or an electron injection layer may be further formed between the organic light emitting layer 254 and the second electrode 255.

A sealing member (not shown) may be disposed to face one surface of the substrate 250. The sealing member for protecting the organic light emitting layer 154 from external moisture or oxygen is formed of a transparent material. To this end, the sealing member may be formed of glass, plastic, or a combination of an organic material and an inorganic material.

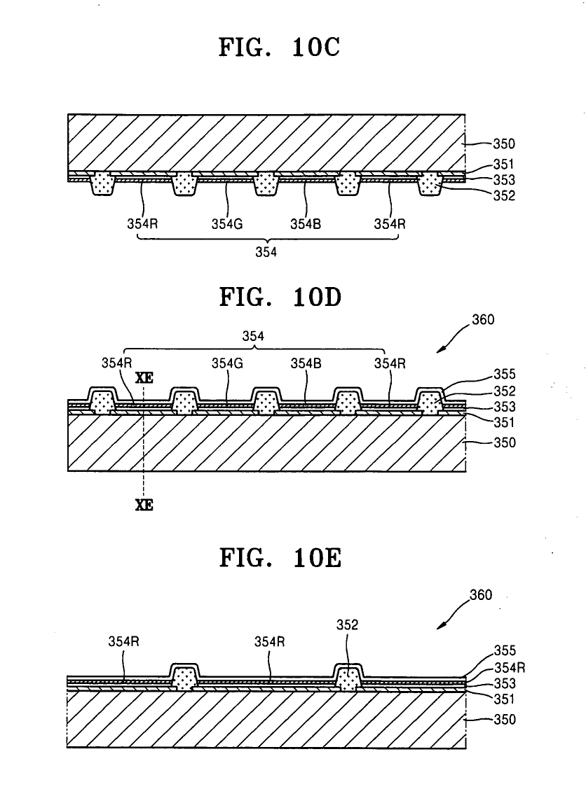

FIGS. 10A through 10E are cross-sectional views illustrating a method of manufacturing an organic light emitting device, according to another embodiment of the present invention. The method will now be explained with reference to FIGS. 10A through 10E.

Referring to FIG. 10A, a substrate 350 is disposed on a deposition apparatus 300. Since the deposition apparatus 300 is the same as the deposition apparatus 300 of FIGS. 5 through 7, a detailed explanation thereof will not be given.

FIG. 10B is a cross-sectional view taken along line XB-XB of FIG. 10A. Referring to FIG. 10B, a first electrode 351, a pixel definition layer 352, and a hole transport/injection layer 353 are formed on the substrate 350. Due to the taken cross-section, what is not illustrated, but will become apparent with respect to FIG. 10E, substrate 350 has the matrix/lattice pattern of FIG. 5 formed of first electrode 351, pixel definition layer 352, and hole transport/injection layer 353.

A heat emitting layer 303 includes a first heat emitting layer 303a, a second heat emitting layer 303b, a third heat emitting layer 303c, a first barrier rib 304a and a second barrier rib 304b of the deposition apparatus 300 of FIGS. 4 through 7.

A deposition material 310R is disposed on the first heat emitting layer 303a, a deposition material 310G is disposed on the second heat emitting layer 303b, and a deposition material 310B is disposed on the third heat emitting layer 303c.

The first through third heat emitting layers 303a, 303b, and 303c are disposed to correspond to a plurality of the hole transport/injection layers 353 each formed between adjacent pixel definition layers 352. The pixel definition layer 352 contacts the barrier rib 304a.

The deposition material 310 for forming an organic light emitting layer includes the deposition material 310R, the deposition material 310G, and the deposition material 310B. The deposition material 310R includes an organic material for forming an organic light emitting layer for emitting red visible light, the deposition material 310G includes an organic material for forming an organic light emitting layer for emitting green visible light, and the deposition material 310B includes an organic material for forming an organic light emitting layer for emitting blue visible light.

The first heat emitting layer 303a is formed to have a width corresponding to red sub-pixels, the second heat emitting layer 303b is formed to have a width corresponding to green sub-pixels, and the third heat emitting layer 303c is formed to have a width corresponding to blue sub-pixels. The barrier ribs 304a are disposed between the first through third heat emitting layers 303a, 303b, and 303c.

Next, a deposition process is performed to heat the deposition material 310R, thereby forming a red organic light emitting layer, to heat the deposition material 310G, thereby forming a red organic light emitting layer, and to heat the deposition material 310B, thereby forming a blue organic light emitting layer. That is, the red, green, and blue organic light emitting layers are formed by performing one deposition process.

Referring to FIG. 10C, deposition apparatus 300 has been removed, an organic light emitting layer 354 including a red organic light emitting layer 354R, a green organic light emitting layer 354G, and a blue organic light emitting layer 354B are illustrated.

Referring to FIG. 10D, a second electrode 355 is formed on organic light emitting layer 354 and pixel definition layer 352, thereby completely manufacturing an organic light emitting device 360.

FIG. 10E is a cross-sectional view taken along line XE-XE of FIG. 10D. Not illustrated in FIGS. 10B-10D, since substrate 350 has a matrix/lattice pattern formed of first electrode 351, pixel definition layer 352, and hole transport/injection layer 353, and since the pixel definition layer 352 is masked by barrier rib 304b, when the deposition process is performed the red organic light emitting layer 354R is not formed on the pixel definition layer 352 and hole transport/injection layer 353.

Although not shown, an electron transport layer or an electron injection layer may be further formed between the organic light emitting layer 354 and the second electrode 355.

A sealing member (not shown) may be disposed to face one surface of the substrate 350. The sealing member for protecting the organic light emitting layer 154 from external moisture or oxygen is formed of a transparent material. To this end, the sealing member may be formed of glass, plastic, or a combination of an organic material and an inorganic material.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A deposition apparatus, comprising:
a base;
a heat blocking layer formed on the base;
a heat emitting layer patterned into stripes and formed on the heat blocking layer to heat a deposition material to be deposited; and
a barrier rib formed and patterned on the heat blocking layer to define a space in which the deposition material is to disposed.

2. The deposition apparatus of claim 1, wherein the heat blocking layer comprises at least one selected from the group consisting of ZrO, (Zirconium Oxide), SiO₂ (Silicon Dioxide), and Al₂O₃ (Aluminum Oxide).

3. The deposition apparatus of claim 1, wherein the heat blocking layer is formed over an entire surface of the base facing the heat emitting layer.

4. The deposition apparatus of claim 1, wherein the heat emitting layer is formed to have a plurality of stripe patterns.

5. The deposition apparatus of claim 4, wherein each of the plurality of stripe patterns has a uniform width from end to end.

6. The deposition apparatus of claim 1, wherein the heat emitting layer is formed to have a plurality of stripe patterns having the same width.

7. The deposition apparatus of claim 4, wherein the barrier rib is formed to have a plurality of stripe patterns that are disposed between the plurality of stripe patterns of the heat emitting layer.

8. The deposition apparatus of claim 4, wherein the heat emitting layer is connected to one common power source.

9. The deposition apparatus of claim 1, wherein the heat emitting layer comprises at least one selected from the group consisting of titanium (Ti), chrome (Cr), copper (Cu), and aluminium (Al).

10. The deposition apparatus of claim 1, wherein the heat emitting layer comprises a first heat emitting layer, a second heat emitting layer, and a third heat emitting layer to enable different deposition materials to be disposed.

11. The deposition apparatus of claim 10, wherein the first heat emitting layer, the second heat emitting layer, and the third heat emitting layer are connected to different power sources.

12. The deposition apparatus of claim 10, wherein each of the first heat emitting layer, the second heat emitting layer, and the third heat emitting layer is formed to have a plurality of stripe patterns.

13. The deposition apparatus of claim 12, wherein each of the plurality of stripe patterns has a uniform width from end to end.

14. The deposition apparatus of claim 12, wherein the plurality of stripe patterns of the first heat emitting layer have a first constant width, the plurality of stripe patterns of the second heat emitting layer have a second constant width, and the plurality of stripe patterns of the third heat emitting layer have a third constant width.

15. The deposition apparatus of claim 12, wherein the barrier rib is formed to have a plurality of stripe patterns that are disposed between the plurality of stripe patterns of the first through third heat emitting layers.

16. The deposition apparatus of claim 1, wherein the barrier rib comprises a first barrier rib and a second barrier rib intersecting the first barrier rib.

17. The deposition apparatus of claim 16, wherein the second barrier rib is disposed on the heat emitting layer.

18. The deposition apparatus of claim 16, wherein the heat emitting layer is comprised of a plurality of stripe layers, the first barrier rib is disposed between adjacent stripe layers and the second barrier rib is disposed on the stripe layers.

19. The method of claim 1, wherein an entire area of the heat emitting layer has a uniform thickness.

20. A method of manufacturing an organic light emitting device using a deposition apparatus comprising a base, a heat blocking layer formed on the base, a heat emitting layer patterned into stripes and formed on the heat blocking layer to heat a deposition material to be deposited, and a barrier rib formed and patterned on the heat blocking layer to define a space in which the deposition material is disposed, the method comprising the steps of:
preparing a substrate comprising a first electrode, and a pixel definition layer disposed on the first electrode to expose a portion of the first electrode;
depositing an organic light emitting material on the heat emitting layer;
forming an organic light emitting layer from the organic light emitting material by supplying power to the heat emitting layer, the organic light emitting layer being electrically connected to the first electrode; and
forming a second electrode on the organic light emitting layer.

21. The method of claim 20, wherein the forming of the organic light emitting layer by using the deposition material comprises disposing the substrate and the deposition apparatus so that the pixel definition layer and the barrier rib contact each other.

22. The method of claim 20, further comprising forming a hole transport/injection layer on the first electrode before the forming of the organic light emitting layer.
